(19) United States
(12) Patent Application Publication
(10) Pub. No.: US 2024/0412146 A1
(43) Pub. Date: Dec. 12, 2024

(54) EVALUATION METHOD, EVALUATION DEVICE AND EVALUATION PROGRAM

(71) Applicant: NIPPON TELEGRAPH AND TELEPHONE CORPORATION, Tokyo (JP)

(72) Inventors: Yuki TANIGUCHI, Musashino-shi, Tokyo (JP); Toshitaka MAKI, Musashino-shi, Tokyo (JP); Masakuni ISHII, Musashino-shi, Tokyo (JP); Takashi FUJINAMI, Musashino-shi, Tokyo (JP)

(73) Assignee: NIPPON TELEGRAPH AND TELEPHONE CORPORATION, Tokyo (JP)

(21) Appl. No.: 18/273,979

(22) PCT Filed: Feb. 5, 2021
(86) PCT No.: PCT/JP2021/004390

§ 371 Date: Jul. 25, 2023

(51) Int. Cl. G06Q 10/0639

(52) U.S. Cl. CPC G06Q 10/06398

(57) ABSTRACT

A relative evaluation calculation unit (15b) calculates a relative evaluation between a first evaluation target person and an evaluation target person other than a first evaluator, for a first item out of items not directly related to the performance at the time of evaluation. An absolute evaluation calculation unit (15c) calculates an absolute evaluation of the first evaluation target person based on a predetermined criterion for a second item. An evaluation unit (15e) evaluates the first evaluator by using at least the first item and the second item.

### TECHNICAL FIELD

The present invention relates to an evaluation method, an evaluation device, and an evaluation program.

### BACKGROUND ART

In general, both quantitative and qualitative indexes are often used as indexes for evaluating human resources. Examples of the quantitative index include the presence/absence of an accomplished goal or a revenue, and examples of the qualitative index include actions taken and attitudes taken. NPL 1 describes likelihood evaluation. The qualitative index is intended to promote a behavior and maintain motivation (see NPL 1).

### CITATION LIST

### Non Patent Literature

[NPL 1] “Basics of Human Resource Development, Vol. 10, Quantitative and Qualitative Evaluation,” [online], Jan. 6, 2021, NTT Learning Systems, [Searched on Jan. 13, 2021], Internet
   <URL: https://hr.nttls.co.jp/column/knowledge/stepl/detail-10.html>

### SUMMARY OF INVENTION

### Technical Problem

However, in the prior art, there are cases where the items that can be evaluated only by qualitative indexes should be evaluated together. For example, sales used as quantitative evaluation in business activities are results, and it is difficult to evaluate the process leading up to those results and the challenges involved in achieving those results.

The present invention has been made in view of the foregoing points, and it is an object hereof to comprehensively evaluate human resources using quantitative and qualitative evaluation indicators.

### Solution to Problem

In order to solve and achieve the above-mentioned problem, an evaluation method according to the present invention is an evaluation method to be executed by an evaluation device, the evaluation method comprising: a relative evaluation calculation step of calculating a relative evaluation between a first evaluation target person and an evaluation target person other than a first evaluator, for a first item out of items not directly related to a business result at the time of evaluation; an absolute evaluation calculation step of calculating an absolute evaluation of the first evaluation target person based on a predetermined criterion for a second item; and an evaluation step of evaluating the first evaluator by using at least the first item and the second item.

### Advantageous Effects of Invention

According to the present invention, human resources can be comprehensively evaluated by using quantitative and qualitative evaluation indexes.

### BRIEF DESCRIPTION OF DRAWINGS

FIG. 1 is a schematic diagram exemplifying an overview configuration of an evaluation device.

FIG. 2 is a diagram for explaining processing of the evaluation device.

FIG. 3 is a diagram for explaining processing of the evaluation device.

FIG. 4 is a flow chart showing an evaluation processing procedure.

FIG. 5 is a diagram exemplifying a computer that executes an evaluation program.

### DESCRIPTION OF EMBODIMENTS

Hereinafter, an embodiment of the present invention will be described in detail with reference to the drawings. The present invention is not limited to the embodiment. Further, in the description of the drawings, the same parts are denoted by the same reference signs.

### [Outline of Evaluation Device]

The present example proposes a means of using an qualitative index in addition to a quantitative index as described above to evaluate human resources.

First, a qualitative index to be evaluated is defined. The quantitative evaluation cannot be performed at a point of time when the evaluation is to be obtained, and the quantitative index in the future is affected by the fluctuation of the index. That is, the qualitative index may be replaced by a predicted value of a future quantitative index.

In order to obtain the qualitative index, parameters such as a behavior and an output of an evaluation target person to be described later, which can be obtained by an evaluator at the time of evaluation, are used. From an end-to-end perspective, this means obtaining a quantitative index for the future by using parameters that can be obtained at the time of evaluation. The above-described quantitative evaluation is a contribution to a business at the time when evaluation is to be obtained, while the qualitative evaluation may be an indicator that has no contribution to the business at the time when the evaluation is to be obtained, but has an impact on the contribution to the business envisaged in the future.

### <Configuration of Evaluation Device>

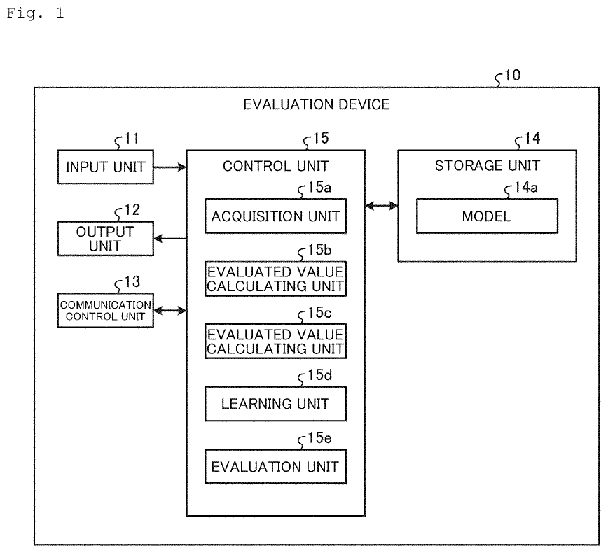

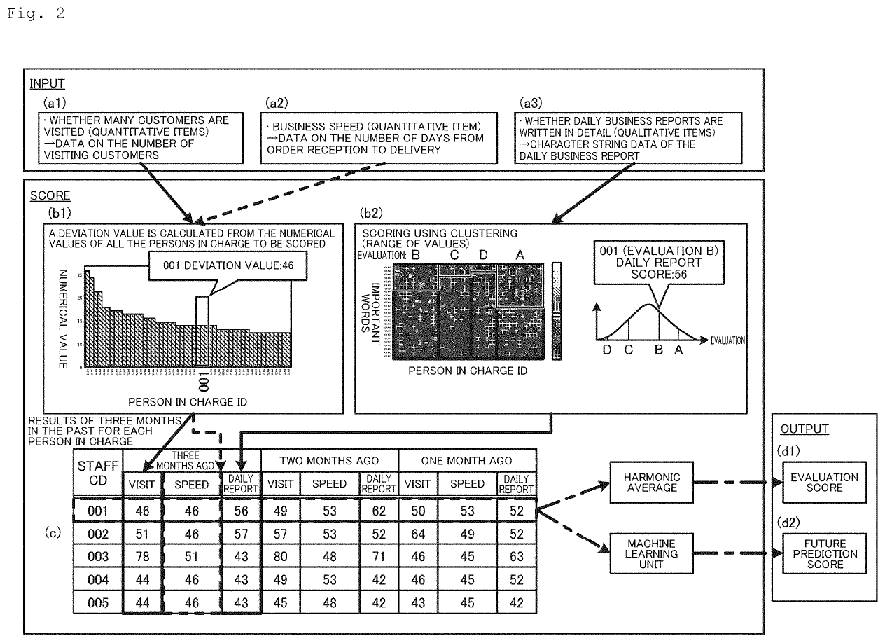

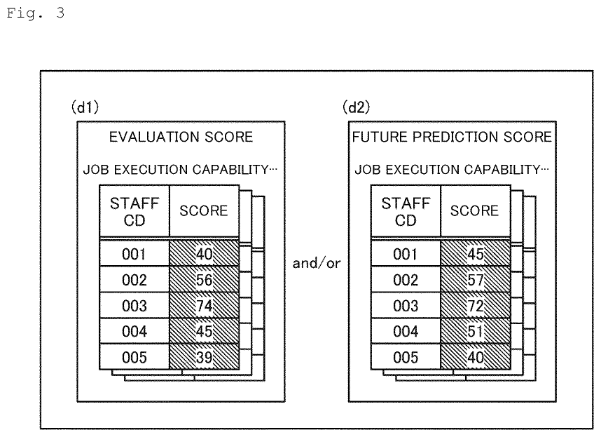

FIG. 1 is a schematic diagram exemplifying an overview configuration of an extraction device. FIGS. 2 and 3 are diagrams for explaining processing of the evaluation device. As illustrated in FIG. 1, an evaluation device 10 of the present embodiment is realized by a general-purpose computer such as a personal computer, and includes an input unit 11, an output unit 12, a communication control unit 13, a storage unit 14, and a control unit 15.

The input unit 11 is realized by using an input device such as a keyboard or a mouse, and inputs various types of instruction information such as the start of processing, to the control unit 15 in response to an input operation by an operator. The output section 12 is realized by a display device such as a liquid crystal display, a printing device such as a printer, an information communication device, and the like. The communication control unit 13 is realized by an NIC (Network Interface Card) or the like, and controls communication between an external device and the control unit 15 via a network, the external device being a business terminal used by an evaluation target person, a management device for managing information on the evaluation target person, or the like.

The storage unit 14 is realized by a semiconductor memory element such as a RAM (Random Access Memory) or a flash memory, or a storage device such as a hard disk or an optical disk. Note that the storage unit 14 may also be configured to communicate with the control unit 15 via the communication control unit 13. In the present embodiment, the storage unit 14 stores, for example, a model 14a used in evaluation processing which will be described later.

The control unit 15 is realized by using a CPU (Central Processing Unit), an NP (Network Processor), an FPGA (Field Programmable Gate Array), or the like, and executes a processing program stored in a memory. Therefore, as exemplified in FIG. 1, the control unit 15 functions as an acquisition unit 15a, a relative evaluation calculation unit 15b, an absolute evaluation calculation unit 15c, a learning unit 15d, and an evaluation unit 15e.

It should be noted that these functional units may be implemented in different hardware. For example, the learning unit 15d may be implemented as a learning device different from the evaluation device 10. The control unit 15 may also include another functional unit.

The acquisition unit 15a acquires predetermined evaluation item data of the evaluation target person. Specifically, the acquisition unit 15a acquires, as an input of the evaluation processing to be described later, evaluation item data used for evaluation of the evaluation target person via the input unit 11 or via the communication control unit 13 from the business terminal, management device, or the like of the evaluation target person. In so doing, the acquisition unit 15a acquires evaluation item data of all evaluation target persons for processing of the relative evaluation calculation unit 15b and the absolute evaluation calculation unit 15c to be described later.

FIG. 2 shows an example in which a sales representative is the evaluation target person. In this case, the evaluation item data is, for example, visited customer number data (a1), data (A2) of the number of visited customers, data (a2) on the number of days from order to delivery, character string data (a3) of daily business daily reports, and the like. The visited customer number data is a quantitative evaluation index representing how many customers are visited. The number of days from order to delivery is a quantitative evaluation index representing a business speed. The character string data of daily business reports can be a qualitative evaluation index indicating whether a daily business report is written in detail. For example, if a daily business report describes, in detail, when, how and for what purpose a customer was visited and who the customer was, then it can be said that the daily business report is written in detail. On the other hand, if a daily business report simply describes “visited” and does not include any information for others to see, it can be said that the daily business report is not written in detail.

Although these evaluation item data cannot be said to directly represent the business performance of the sales representative on their own, they can be one of the evaluation indexes of the overall business performance which can be evaluated by combining a plurality of evaluation indexes. The evaluation device 10 combines these quantitative evaluation indexes and qualitative evaluation indexes in the evaluation processing to be described later, to perform comprehensive evaluation of each evaluation target person.

For example, the business performance of the evaluation target person is evaluated by using the evaluation item data shown by (a1) to (a2) of FIG. 2. Alternatively, the challenging spirit of the evaluation target person is evaluated by using data on the number of orders received from customers who have never ordered before, data on the number of orders for campaign products, and the like.

Returning to the description of FIG. 1, the relative evaluation calculation unit 15b calculates a relative evaluation between a first evaluation target person and an evaluation target person other than the first evaluator, for a first item among items not directly related to a business result at the time of evaluation. Specifically, as exemplified in FIG. 2 (b1), the relative evaluation calculation unit 15b calculates relative evaluation scores such as deviation values among all evaluation target persons, for each of the quantitative evaluation indexes acquired by the acquisition unit 15a.

Here, the deviation values are calculated by the following equation (1) using a score x of each evaluation target person, an average score μ of all the evaluation target persons, and a standard deviation σ.

$$Deviation value = 10 \times ( x - μ ) / σ + 50 \qquad ( 1 )$$

In the example shown in FIG. 2 (b1), a deviation value 46 of the visited customer number data is calculated for a representative 001. The relative evaluation calculation unit 15b similarly calculates a deviation value of the number of days from order to delivery for the representative 001.

Returning to the description of FIG. 1, the absolute evaluation calculation unit 15c calculates the absolute evaluation of the first evaluation target person based on a predetermined criterion, for a second item. Specifically, as exemplified in FIG. 2 (b2), the absolute evaluation calculation unit 15c calculates the absolute evaluation of the evaluation target person for each of the qualitative evaluation indexes acquired by the acquisition unit 15a. The absolute evaluation calculation unit 15c also clusters each evaluation target person to calculate absolute evaluation, and converts it into relative evaluation for all the evaluation target persons.

In the example shown in FIG. 2 (b2), the number of predetermined important words included in the character string data of the daily business report of each evaluation target person is tallied. In addition, the data are clustered in the range of the number of important words in the daily business report of each evaluation target person, and classified into four clusters, that is, a cluster A evaluated as a detailed daily business report to a cluster D evaluated as a poor daily business report.

In addition, a deviation value of the evaluation target person of each cluster among all evaluation target persons is calculated according to the number of persons of each cluster. In FIG. 2 (b2), a deviation value 56 of the evaluation B is calculated as a score of the representative 001 classified into class B. In this manner, the absolute evaluation calculation unit 15c scores the qualitative evaluation items as absolute evaluation and converts them into relative evaluation. Thus, the evaluation device 10 can include qualitative evaluation items in a comprehensive evaluation to be described later.

Description will return to FIG. 1. The learning unit 15d will be described later.

The evaluation unit 15e evaluates the first evaluator by using the first item and/or the second item. For example, the evaluation unit 15e combines the quantitative evaluation items and the qualitative evaluation items as illustrated in FIG. 2(c), to comprehensively evaluate each evaluation target person. In the example shown in FIG. 2(c), comprehensive evaluation of each evaluation target person is calculated by using the visited customer number data and the number of days from order to delivery, which are quantitative items, and the character string data of a daily business report, which is a qualitative item.

As the comprehensive evaluation, the evaluation unit 15e evaluates the first evaluator by using, for example, a harmonic average of the most recent relative evaluation and absolute evaluation. Specifically, when the manager evaluates every three months, the evaluation unit 15e calculates a harmonic average of a relative evaluation score for the most recent past three months for every evaluation target person and a score of absolute evaluation converted into relative evaluation as shown in FIG. 2(c) to FIG. 2 (d1), as an achievement evaluation score which is a comprehensive evaluation of the achievement of the evaluation target person.

In the example shown in FIG. 2(c) to FIG. 2 (d1), the harmonic average for the most recent past three months of the deviation value of the visited customer number data which is a quantitative evaluation item, the deviation value of the number of days from order to delivery, and the deviation value obtained by scoring the character string data of the daily business report which is a qualitative evaluation item, is calculated as the achievement evaluation score.

When the manager evaluates every month, the evaluation unit 15e sets the harmonic average of the scores of the evaluation one month prior, as the achievement evaluation score. For example, in the example shown in FIG. 2, the harmonic average of the scores 50, 53 and 52 of the visits, speed and daily report of 001 one month prior is assumed to be the achievement evaluation score of 001. In this manner, the time width of the most recent data used for the evaluation is appropriately changed according to the interval of the evaluations by the manager.

Alternatively, the evaluation unit 15e calculates the comprehensive evaluation by using at least the future evaluation from the evaluation time point onward that is predicted from the relative evaluation and the absolute evaluation.

In this case, the learning unit 15d constructs the model 14a for predicting the future evaluation of each evaluation target person from the most recent relative evaluation and absolute evaluation of each evaluation target person. The model 14a is constructed by learning the degree of contribution to the comprehensive evaluation of each evaluation item.

For example, the model 14a for determining the degree of contribution is constructed by learning in advance the comprehensive evaluation for the next six months or the like with respect to three months worth of evaluation items of all representatives for three months. Then, the three months worth of evaluation items of the representative 001 is input to the model 14a, to calculate the degree of contribution to the future comprehensive evaluation of each evaluation item. In this manner, the model 14a can predict the impact of the most recent behavior of each evaluation target person on the future, and output a predicted value of future comprehensive evaluation such as six months later.

The evaluation unit 15e calculates a future prediction score which is a predicted value for future comprehensive evaluation, by inputting the most recent past relative evaluation score for each evaluation target person and the score of absolute evaluation converted into relative evaluation, or either of them, to the generated model 14a, as shown in FIG. 2(c) to FIG. 2 (d2) . . .

As shown in FIG. 3, the evaluation unit 15e outputs at least one of the achievement evaluation score and the future prediction score. As shown in FIG. 3 (d1), the achievement evaluation score shows an achievement evaluation score representing the comprehensive evaluation of the achievement of each evaluation target person. For example, the achievement evaluation score of the representative 001 is 40. FIG. 3 (d2) illustrates the future prediction score representing a comprehensive evaluation predicted from the past behavior of each evaluation target person. For example, the future prediction score of the representative 001 is 45. Thus, the evaluation device 10 can output the comprehensive evaluation of the achievement and the predicted value of the future comprehensive evaluation by using the quantitative evaluation indexes and the qualitative evaluation indexes.

### [Evaluation Processing]

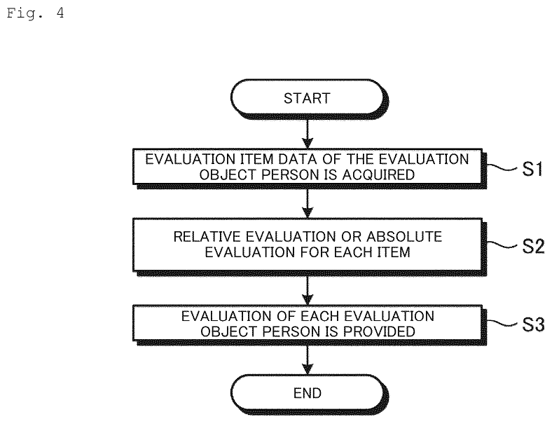

Next, evaluation processing executed by the evaluation device 10 will be described. FIG. 4 is a flowchart illustrating an evaluation processing procedure. The flowchart shown in FIG. 4 is started, for example, at the timing at which an instruction to start the evaluation processing is received.

First, the acquisition unit 15a acquires predetermined evaluation item data of an evaluation target persons (step S1). In so doing, the acquisition unit 15a acquires evaluation item data of all evaluation target persons in order to calculate relative evaluation.

Next, the relative evaluation calculation unit 15b calculates relative evaluation for the quantitative items. The absolute evaluation calculation unit 15c calculates absolute evaluation of the evaluation target persons based on a predetermined criterion for the qualitative items (step S2). In so doing, the absolute evaluation calculation unit 15c clusters each evaluation target person to calculate absolute evaluation, and converts it into relative evaluation for all evaluation target persons.

Then, the evaluation unit 15e outputs the evaluation of each evaluation target person (step S3). For example, the evaluation unit 15e outputs the comprehensive evaluation of an achievement by using the harmonic average of the most recent relative evaluation and absolute evaluation for each evaluation target person.

Alternatively, the evaluation unit 15e outputs the future evaluation from the evaluation time point onward that is predicted from the relative evaluation and the absolute evaluation. In this case, the learning unit 15d constructs, by learning, the model 14a for predicting the future evaluation of each evaluation target person from the most recent past relative evaluation and absolute evaluation of each evaluation target person. Then, the evaluation unit 15e outputs the future evaluation of each evaluation target person by using the constructed model 14a. This completes a series of estimation processing.

As described above, in the evaluation device 10 of the present embodiment, the relative evaluation calculation unit 15b calculates the relative evaluation between the first evaluation target person and an evaluation target person other than the first evaluator, for the first item out of the items not directly related to the performance at the time of evaluation. The absolute evaluation calculation unit 15c calculates the absolute evaluation of the first evaluation target person based on a predetermined criterion, for the second item. The evaluation unit 15e evaluates the first evaluator by using at least the first item and the second item. Thus, the evaluation device 10 can comprehensively evaluate the evaluation target persons by using the quantitative evaluation indexes and the qualitative evaluation indexes.

The absolute evaluation calculation unit 15c clusters each evaluation target person to calculate the absolute evaluation, and converts it into relative evaluation for all evaluation target persons. Thus, the evaluation device 10 can include the qualitative evaluation items in the comprehensive evaluation.

The evaluation unit 15e evaluates the first evaluator by using the harmonic average of the most recent relative evaluation and absolute evaluation. Therefore, the achievements of the evaluation target persons can be comprehensively evaluated.

The evaluation unit 15e uses at least the future evaluation from the evaluation time point onward that is predicted from the relative evaluation and the absolute evaluation. In this case, the learning unit 15d constructs the model 14a for predicting the future evaluation of each evaluation target person, from the most recent relative evaluation and absolute evaluation of each evaluation target person. Thus, the evaluation device 10 can learn what kind of impact the most recent behavior has on the future, and predict the future comprehensive evaluation.

### [Program]

It is also possible to create a program in which the processing executed by the evaluation device 10 according to the above embodiment is described in a language executable by a computer. As one embodiment, the evaluation device 10 can be implemented by installing an evaluation program for executing the foregoing evaluation processing as package software or online software in a desired computer. For example, by causing an information processing device to execute the foregoing evaluation program, the information processing device can be caused to function as the evaluation device 10. The information processing device also includes mobile communication terminals such as smartphones, mobile phones and PHS (Personal Handyphone System) and slate terminals such as PDA (Personal Digital Assistants). Furthermore, the functions of the evaluation device 10 may be implemented in a cloud server.

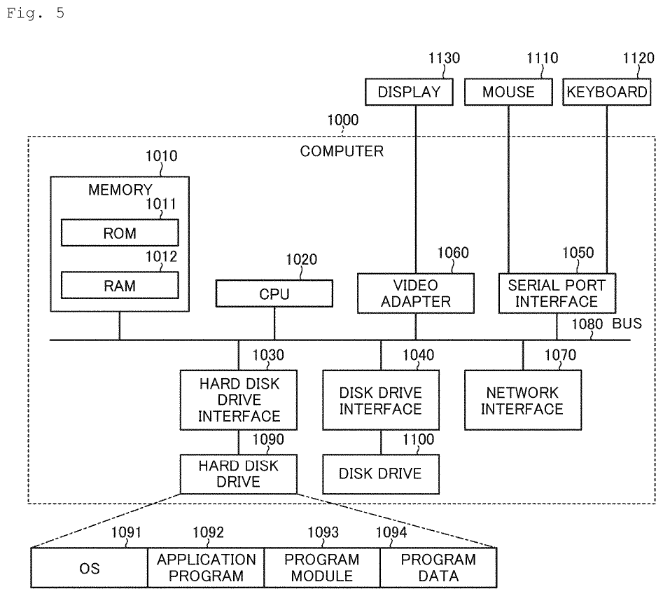

FIG. 5 is a diagram showing an example of a computer that executes the evaluation program. A computer 1000 has a memory 1010, a CPU 1020, a hard disk drive interface 1030, a disk drive interface 1040, a serial port interface 1050, a video adapter 1060, and a network interface 1070, for example. These units are connected by a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to a hard disk drive 1031. The disk drive interface 1040 is connected to a disk drive 1041. A detachable storage medium such as a magnetic disk or an optical disk, for example, is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. Each of the pieces of information described in the above embodiment is stored in, for example, the hard disk drive 1031 or the memory 1010.

The evaluation program is stored in the hard disk drive 1031 as the program module 1093 in which commands executed by the computer 1000 are described, for example. Specifically, the program module 1093 in which each processing executed by the evaluation device 10 described in the foregoing embodiment are described is stored in the hard disk drive 1031.

The data used for information processing by the evaluation program is stored in the hard disk drive 1031, for example, as the program data 1094. Thereafter, the CPU 1020 reads out and loads the program module 1093 and the program data 1094 stored in the hard disk drive 1031 to the RAM 1012 when necessary, and executes each of the procedures described above.

Note that the program module 1093 and the program data 1094 related to the evaluation program are not limited to being stored in the hard disk drive 1031, and may also be stored in, for example, a removable storage medium and read out by the CPU 1020 via the disk drive 1041 or the like. Alternatively, the program module 1093 and the program data 1094 related to the evaluation program may be stored in another computer connected via a network such as a LAN (Local Area Network) or WAN (Wide Area Network), and may be read by the CPU 1020 via the network interface 1070.

Although the above has described an embodiments to which the invention made by the present inventor has been applied, the present invention is not limited by the description and the drawings that form a part of the disclosure of the present invention according to the present embodiment. That is, other embodiments, examples, operational techniques, and the like made by those skilled in the art or the like on the basis of the present embodiment are all included in the category of the present invention.

### REFERENCE SIGNS LIST

10 Evaluation device
11 Input unit
12 Output unit
13 Communication control unit
14 Storage unit
14a Model
15 Control unit
15a Acquisition unit
15b Relative evaluation calculation unit
15c Absolute evaluation calculation unit
15d Learning unit
15e Evaluation unit

1. An evaluation method, comprising:
calculating a relative evaluation between a first evaluation target person and an evaluation target person other than a first evaluator, for a first item out of items not directly related to a business result at the time of evaluation;
calculating an absolute evaluation of the first evaluation target person based on a predetermined criterion for a second item; and
evaluating the first evaluator by using at least the first item and the second item.

2. The evaluation method according to claim 1, wherein:
the calculating the absolute evaluation calculates the absolute evaluation by clustering each evaluation target person, and converts the absolute evaluation into a relative evaluation for all evaluation target persons.

3. The evaluation method according to claim 1, wherein:
the evaluating evaluates the first evaluator by using a harmonic average between the relative evaluation and the absolute evaluation which are most recent evaluations.

4. The evaluation method according to claim 1, wherein:
the evaluating uses at least a future evaluation from an evaluation time point onward that is predicted from the relative evaluation and the absolute evaluation.

5. The evaluation method according to claim 4, further comprising:
learning by constructing a model for predicting future evaluation of each evaluation target person from the relative evaluation and the absolute evaluation of each evaluation target person, which are the most recent evaluations.

6. An evaluation device, comprising:
relative evaluation calculation circuitry configured to calculate a relative evaluation between a first evaluation target person and an evaluation target person other than a first evaluator, for a first item out of items not directly related to a business result at the time of evaluation;
absolute evaluation calculation circuitry configured to calculate an absolute evaluation of the first evaluation target person based on a predetermined criterion for a second item; and
evaluation circuitry configured to evaluate the first evaluator by using at least the first item and the second item.

7. A non-transitory computer readable medium storing an evaluation program that causes a computer to execute:
calculating a relative evaluation between a first evaluation target person and an evaluation target person other than a first evaluator, for a first item out of items not directly related to a business result at the time of evaluation;
calculating an absolute evaluation of the first evaluation target person based on a predetermined criterion for a second item; and
evaluating the first evaluator by using at least the first item and the second item.
